(19) United States
(12) Patent Application Publication
(10) Pub. No.: US 2024/0418316 A1
(43) Pub. Date: Dec. 19, 2024

(54) SYSTEM AND METHOD FOR STORING AND PROCESSING HYDROCARBONS

(71) Applicant: Petrosmith Equipment, LP, Abiline, TX (US)

(72) Inventors: Robert Garrett Lee, Houston, TX (US); Wasif Abdul Aziz, Katy, TX (US); Michael Todd Garrett, Abilene, TX (US); Joshua J Davis, Ovalo, TX (US); Ronald Wayne Farmer, Tuscola, TX (US); Michael James Quillian Duffy, Clyde, TX (US)

(73) Assignee: Petrosmith Equipment, LP, Abiline, TX (US)

(21) Appl. No.: 18/747,902

(22) Filed: Jun. 19, 2024

Related U.S. Application Data
(60) Provisional application No. 63/509,016, filed on Jun. 19, 2023.
(60) Provisional application No. 63/661,761, filed on Jun. 19, 2024.

(51) Int. Cl. F17C 1/00; F17C 7/00

(52) U.S. Cl. CPC F17C 1/00; F17C 7/00; F17C 2221/032; F17C 2223/033; F17C 2227/045

(57) ABSTRACT

A system for both housing hydrocarbons in both liquid and gaseous forms has a body configured to withstand both storage related internal pressures as well as processing related vacuum pressures. A method includes receiving hydrocarbons into a body configured to withstand both storage related internal pressures as well as processing related vacuum pressures.

### CROSS-REFERENCE TO RELATED APPLICATIONS

This application claims the benefit of U.S. Provisional Application No. 63/509,016, filed 19 Jun. 2023, and U.S. Provisional Application No. 63/661,761, filed 19 Jun. 2024.

### STATEMENT REGARDING FEDERALLY SPONSORED RESEARCH OR DEVELOPMENT

Not applicable.

### BACKGROUND

Venting and flaring of hydrocarbon gasses is increasingly being viewed as both environmentally harmful and a waste of natural resources. Conventional hydrocarbon production environments utilize vessel trains that include tanks specified by the American Petroleum Institute (API) as, for example, API 12f storage tanks. API 12f storage tanks and similar API approved tanks necessarily include a so-called thief hatch used for sampling contents of the tank, providing access to the interior of the tank for level gauging, and for providing overpressure and vacuum protection. The API 12f storage tanks and similar API specified storage tanks are deficient in some applications because they inherently provide for venting hydrocarbon gasses to the atmosphere and/or to a flare system for burning vented hydrocarbon gasses. Further, storage tanks are generally not constructed to withstand vacuum pressures that can be useful in a hydrocarbon processing environment. Therefore, there remains a need for a vessel that is capable of providing both hydrocarbon storage while also withstanding commercially beneficial vacuum pressures, in some cases while providing the capabilities within a same footprint as an API 12f or similar storage tank.

### BRIEF DESCRIPTION OF THE DRAWINGS

FIG. 1 is a schematic view of a system according to an embodiment of this disclosure, comprising a Tessel according to an embodiment of this disclosure.

FIG. 2 is a schematic view of a system according to another embodiment of this disclosure, comprising a Tessel according to an embodiment of this disclosure.

FIG. 3 is a partially transparent oblique view of the Tessel of FIGS. 2 and 3.

FIG. 4 is a flowchart of a method of operating a system according to an embodiment of this disclosure.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

This disclosure divulges systems and methods for providing both hydrocarbon storage and hydrocarbon processing capability using a single vessel within a conventional API storage tank footprint.

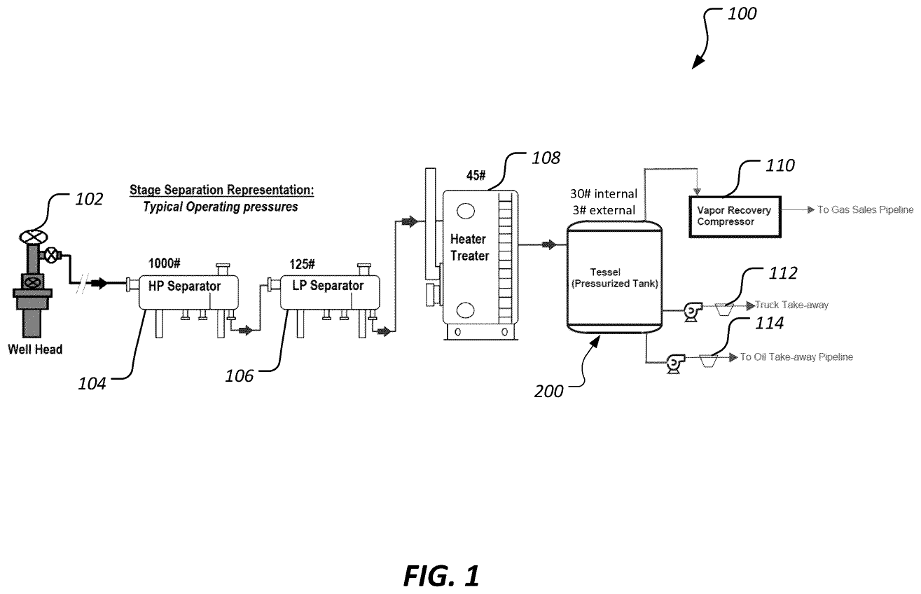

Referring now to FIG. 1, a system 100 according to an embodiment of this disclosure is shown. System 100 comprises a well head 102, a high pressure separator 104, a low pressure separator 106, a heater treater 108, a Tessel 200 according to this disclosure, a vapor recovery compressor 110, a truck take-away 112, and an oil takeaway pipeline 114. The term, Tessel, is an applicant constructed term intended to connotate the combined functionality of both a storage tank and a pressure vessel. System 100 is configured as a stage separation vessel train for use within typical operating pressures. For example, high pressure separator 104 is configured for operation at pressures of up to about 1000 psig while low pressure separator 106 is configured for operation at pressure of up to about 125 psig and heater treater 108 is configured for operation at pressures up to about 45 psig. In this embodiment, hydrocarbons are passed from well head 102 to high pressure separator 104. After some hydrocarbons are removed from use of the high pressure separator 104, remaining hydrocarbons are passed to low pressure separator 106. After some hydrocarbons are removed from use of the low pressure separator 106, remaining hydrocarbons are passed to heater treater 108 for heat treatment and further processing. Hydrocarbons are subsequently passed from heater treater 108 to Tessel 200, which can withstand both operating and storage pressures up to 30 psig, as well as external pressures (vacuum pressure) up to 3 psig. It is important to note that conventional API 12f storage tanks and other conventional tanks are not capable of withstanding the above-described vacuum pressure related external loads. Hence, Tessel 200 is novel in the least because it can serve as both a hydrocarbon storage device as well as a hydrocarbon processing device that requires both relatively higher operating pressures, and higher negative pressures (vacuum pressure) for processing, compared to a traditional API 12F tank.

In this embodiment, hydrocarbon gasses can be removed from Tessel 200 through the use of vapor recovery compressor 110 which works to apply the above-mentioned vacuum pressure to Tessel 200. By applying the vacuum pressure, hydrocarbon gases can be captured for further processing as opposed to being merely vented to atmosphere or combusted using a flare device. Further, because Tessel 200 is configured to occupy substantially the same physical footprint of an API 12f storage tank, existing vessel trains can easily be retrofitted and provided processing functionality by replacing an API 12f storage tank with a Tessel 200. System 100 is well-suited for providing the above-described functionality without the need for a vapor recovery tower.

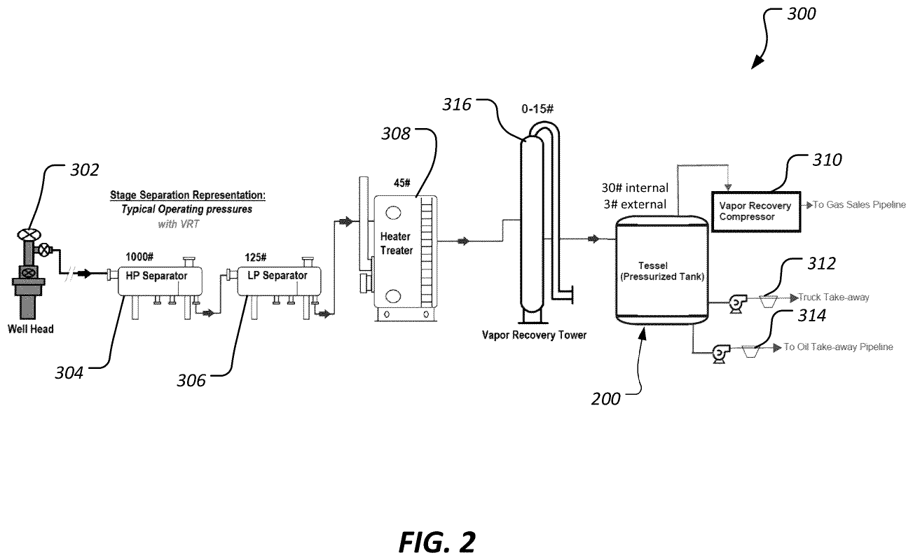

Referring now to FIG. 2, a system 300 according to an embodiment of this disclosure is shown. System 300 comprises a well head 302, a high pressure separator 304, a low pressure separator 306, a heater treater 308, a vapor recovery tower 316, a Tessel 200 according to this disclosure, a vapor recovery compressor 310, a truck take-away 312, and an oil takeaway pipeline 314. System 300 operates substantially similarly as system 100, but with the added operation of vapor recover tower 316. Vapor recovery tower 316 is disposed between heater treater 308 and Tessel 200. Vapor recover tower 316 receives hydrocarbons from heater treater 308 and operates as a vertical separator to recover flash gas emissions. Hydrocarbons are subsequently passed from vapor recovery tower 316 to Tessel 200.

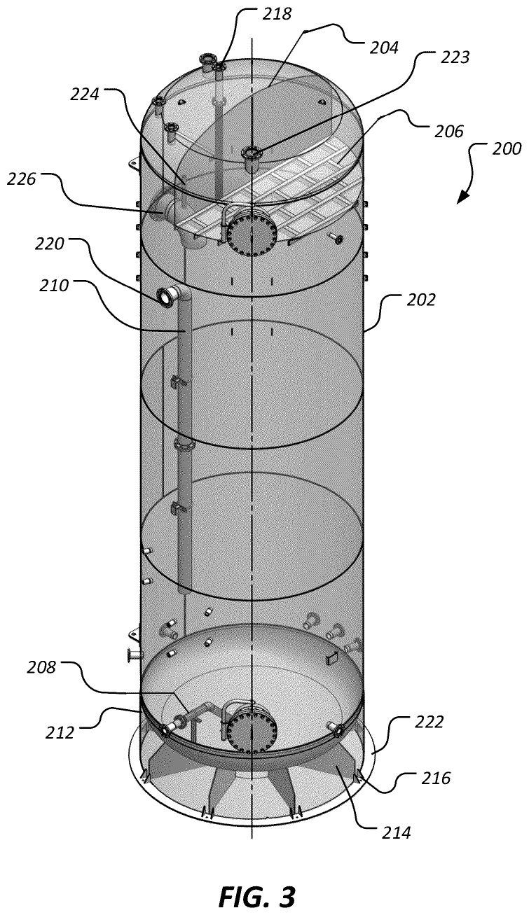

Referring now to FIGS. 3, Tessel 200 is shown in greater detail with a partially transparent oblique view. Tessel 200 comprises a body 202 that substantially defines an interior space. Body 202 is configured to withstand about 15 psig to about 30 psig or more internal pressure as well as up to about 3 psig or more of vacuum pressure.

Tessel 200 further comprises an optional internal gas chamber baffle 204, an optional gas chamber platform 206, a syphon drain 208, an inlet downcomer assembly 210, a skirt 212, first external skirt gussets 214, second external skirt gussets 216, a vapor bypass 218, an oil outlet 220, a base plate 222, gas outlet 223, and a gas break-out 224 connected to an inlet 226, among other caps, fluid conduits, sight glasses, manways, and other components. Most generally, hydrocarbons can be introduced into Tessel 200 via inlet 226 and liquid hydrocarbons can exit Tessel 200 via oil outlet 220 while gaseous hydrocarbons can exit Tessel 200 via gas outlet.

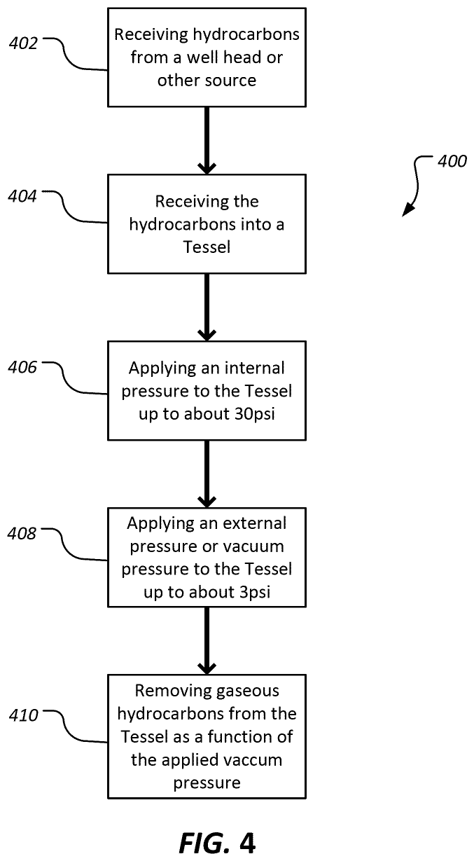

Referring now to FIG. 4, a method 400 of operating a vessel train such as system 100 is shown. At block 402, hydrocarbons can be received from a well head or other source of hydrocarbons. At block 404, hydrocarbons can be introduced to a Tessel such as Tessel 200 through an inlet. At block 406, an internal pressure can be applied to a Tessel while housing the hydrocarbons, such as, for example, from about 15 psig to about 30 psig or more. At block 408, a vacuum pressure can be applied to the Tessel up to about 3 psig, for example. At block 410, gaseous hydrocarbons can be removed from the Tessel as a function of the applied vacuum pressure.

It will be appreciated that alternative embodiments contemplated can comprise Tessels of different sizes and shapes, different limits on internal pressures, different limits on external or vacuum pressures, and may generally be constructed in any other suitable manner to provide the above-described functionality of simultaneously serving as a hydrocarbon storage tank as well as a hydrocarbon pressure vessel suitable for processing hydrocarbons, namely withstanding significant vacuum pressures.

It will be appreciated that various Tessel configurations contemplated herein can withstand internal pressures of various pressure ranges, such as, but not limited to internal pressures of at least about 15 psig to about 35 psig, at least about 20 psig to about 30 psig, at least about 25 psig to about 30 psig, and any other suitable internal pressure rating, such as a pressure rating that qualifies for being rated as an American Society of Mechanical Engineers (ASME) certified component. Further, various Tessel configurations contemplated herein can withstand external pressures or vacuum pressures of at least about 2 pisg to about 6 psig, at least about 3 psig to about 5 psig, and at least about 3 psig to about 4 psig. It is important to note that in conventional vessel trains using only API 12F storage tanks, a vapor recovery tower is required to utilize a vapor recovery unit. However, a distinct advantage of using a Tessel according to an embodiment of this disclosure, a vapor recovery unit can be utilized without a vapor recovery tower because the functionality of one or more of the Tessels disclosed herein are to provide both the functionality of a hydrocarbon storage device as well as the functionality of a vapor recovery tower, namely, serving as a pressure vessel that runs not only vapors but also fluid through it to separate gasses from liquids.

At least one embodiment is disclosed, and variations, combinations, and/or modifications of the embodiment(s) and/or features of the embodiment(s) made by a person having ordinary skill in the art are within the scope of this disclosure. Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed.

Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A system for both housing hydrocarbons in both liquid and gaseous forms, comprising:
a body configured to withstand both storage related internal pressures as well as processing related vacuum pressures.

2. The system of claim 1, further comprising:
an internal gas chamber baffle.

3. The system of claim 1, further comprising:
a gas chamber platform.

4. The system of claim 1, further comprising:
an oil outlet; and
a gas outlet.

5. The system of claim 1, wherein the body is configured to withstand internal pressures of about 15 psig to about 30 psig and vacuum pressures up to at least about 3 psig.

6. The system of claim 1, wherein the system is configured to fit within a physical footprint of an API standard storage tank.

7. A method, comprising:
receiving hydrocarbons into a body configured to withstand both storage related internal pressures as well as processing related vacuum pressures.

8. The method of claim 7, further comprising:
providing the body in a physical footprint of an API standard storage tank.

9. The method of claim 7, further comprising:
removing gaseous hydrocarbons from the body as a function of the applied vacuum pressure.

10. The method of claim 7, wherein the body is configured to withstand internal pressures of about 15 psig to about 30 psig and vacuum pressures up to at least about 3 psig.
